(19) United States
(12) Patent Application Publication
(10) Pub. No.: US 2018/0189033 A1
(43) Pub. Date: Jul. 5, 2018

(54) GRAPHICAL SOFTWARE META-DEVELOPMENT TOOL

(71) Applicant: TechRev, LLC, Milpitas, CA (US)

(72) Inventors: VIJAY NARANG, PEMBROKE PINES, FL (US); SANJAY NARANG, PEMBROKE PINES, FL (US); RAMACHANDRAN RAMASUBBU, PEMBROKE PINES, FL (US)

(73) Assignee: TechRev, LLC

(21) Appl. No.: 15/393,571

(22) Filed: Dec. 29, 2016

(51) Int. Cl. G06F 9/44

(52) U.S. Cl. CPC G06F 8/34; G06F 8/35

(57) ABSTRACT

A developer's efficiency workbench (DEW) tool can include a DEW model module, a presentation module, a code abstraction module, a language library, and a code generator. The DEW model module can allow creation of a DEW model, a list of user-defined data entities. The presentation module can allow the creation of presentations that define graphical user interfaces (GUIs) whose elements can be linked with the DEW model. The code abstraction module can allow the creation of a code abstraction; a high-level, graphical, platform and programming language independent representation of the behaviors performed by the software application. Elements of the code abstraction can be linked to DEW model or presentations. The language library can store syntax and/or software code for programming languages. The code generator can use the language library to synthesize the DEW model, presentations, and code abstraction into executable software code without manual authoring by a user.

### BACKGROUND

The present invention relates to the field of software development and, more particularly, to a software meta-development tool.

The software development process often relies upon the use of one or more tools to increase developer productivity and decrease project time. A variety of tools, the most common being an integrated development environment (IDE), are available for writing the code for the software application. The majority of the available tools are focused on authoring the software application's code for use with a specific computing platform and/or using a specific programming language or family of languages; typically by automating repeated tasks and/or enforcing restrictions.

Since the textual software code is written with for a specific platform/programming language, code reusability is limited. When a software application needs to be available for use on multiple platforms, the application will often need to be expressed using different programming languages, increasing the overhead and resources required for the development process.

Still, a tool works only as well as the person using it. Conventional software development tools requires developers who are well versed in the nuances of the tool, as well as a specific platform and/or programming language. While there are tools that provide greater automation for code generation (i.e., CODESMITH Tools), these tools are still focused on low-level expressions of software application functionality. That is, conventional tools focus on specific, often platform and/or programming language dependent, code expressions. These primarily text-based representations make it difficult to visualize how various functions and data are related.

What is needed is a software development tool that allows for software code to be graphically represented using high-level concepts. Such a solution should utilize platform and programming language independent terminology.

### BRIEF SUMMARY

One aspect of the present invention can include a developer's efficiency workbench (DEW) tool comprised of a DEW model module, a presentation module, a code abstraction module, a language library, and a code generator. The DEW model module can be configured to create a DEW model for a software application. The DEW model can be a list of user-defined data entities available for use by the software application. The presentation module can be configured to create presentations for the software application. A presentation can define a graphical user interface (GUI) for the software application. The GUI elements defined in the presentation can be linked with respective data entities in the DEW model. The code abstraction module can be configured to create a code abstraction for the software application. The code abstraction can be a high-level, graphical, platform and programming language independent representation of behaviors performed by the software application. The elements of the code abstraction can be linked to corresponding data entities of the DEW model or GUI elements of the presentations. The language library can store syntax and/or software code for programming languages. The code generator can be configured to synthesize the DEW model, presentations, and code abstraction into a set of executable software code implementing the software application using the language library without the need for a user to manually author the software code.

Another aspect of the present invention can include a software development method that begins with the creation of a DEW model for a software application in a developer's efficiency workbench (DEW) tool. The DEW model can be a list of user-defined data entities available for use by the software application. One or more presentations can be created for the software application. A presentation can define a graphical user interface (GUI) for the software application. The GUI elements defined in the presentation can be linked with respective data entities in the DEW model. A code abstraction can be created for the software application. The code abstraction can be a high-level, graphical, platform and programming language independent representation of behaviors performed by the software application. The elements of the code abstraction can be linked to corresponding data entities of the DEW model or GUI elements of the presentations. A set of executable software code implementing the software application can be generated as defined in the DEW model, presentations, and the code abstraction. The software code can be generated for execution on a user-specified platform and/or using a user-specified programming language, without manual authoring of the software code by a user.

Yet another aspect of the present invention can include a computer program product that includes a computer readable storage medium having embedded computer usable program code. The computer usable program code can be configured to allow creation of a DEW model for a software application. The DEW model can be a list of user-defined data entities available for use by the software application. The computer usable program code can be configured to allow creation of one or more presentations for the software application. A presentation can define a graphical user interface (GUI) for the software application. The GUI elements defined in the presentations can be linked with respective data entities in the DEW model. The computer usable program code can be configured to allow creation of a code abstraction for the software application. The code abstraction can be a high-level, graphical, platform and programming language independent representation of behaviors performed by the software application. The elements of the code abstraction can be linked to corresponding data entities of the DEW model or GUI elements of the presentations. The computer usable program code can be configured to generate a set of executable software code implementing the software application as defined by the DEW model, presentations, and the code abstraction. The software code can be generated for execution on a user-specified platform and/or using a user-specified programming language, without manual authoring of the software code by a user.

### BRIEF DESCRIPTION OF THE SEVERAL VIEWS OF THE DRAWINGS

FIG. 1 is an illustration expressing the basic premise of a software meta-development tool, the developer's efficiency workbench (DEW) tool in accordance with embodiments of the inventive arrangements disclosed herein.

FIG. 2 is a block diagram illustrating a system implementing a software meta-development tool, the developer's efficiency workbench (DEW) tool in accordance with embodiments of the inventive arrangements disclosed herein.

FIG. 3 is a flowchart of a method describing the general use of the DEW tool in accordance with embodiments of the inventive arrangements disclosed herein.

FIG. 4 is an illustration of an example DEW tool GUI used to define the data entities of the DEW model in accordance with embodiments of the inventive arrangements disclosed herein.

FIG. 5 depicts example DEW tool GUIs for creating a presentation in accordance with embodiments of the inventive arrangements disclosed herein.

FIG. 6 shows examples DEW tool GUIs for creating a code abstraction in accordance with embodiments of the inventive arrangements disclosed herein.

### DETAILED DESCRIPTION

The present invention discloses a tool for automatically generating software application code where the source document for the software code is expressed graphically in a platform and programming language independent manner. The developer's efficiency workbench (DEW) tool can represent the source of a software application to be represented as a DEW model, one or more presentations, and a code abstraction. The DEW model can define the data entities used by the software application. The presentations can define the user interfaces for the software application as well as associate elements of the GUI with their related data entities. The code abstraction can be a high-level, platform and programming language independent, graphical representation of the behaviors performed by the software application. The DEW tool can translate the DEW model, presentations, and code abstraction into the software code for a specific platform and/or programming language.

Embodiments of the disclosure provide a graphical tool (which generates code; which permits code-based additions; which does not require developers to rely on code as the DEW tool is able to function as a pure GUI coding toolkit) for rapidly creating platform and/or programming language independent applications in accordance with a Model-View-Whatever (MV*) pattern. The MV* pattern includes, but is not limited to a Model-View-Controller (MVC) pattern, a Model-View-View Model (MVVM) pattern, and a Model-View-Presenter (MVP) pattern. Effectively, different portions of the code are created in different divisions from each other. One division represent the “Model”, one represents the “View”, and another represents a “Controller”, “Presenter”, and/or “View Model”. That is, the DEW tool is compatible with different specific design patterns conforming to or consistent with the MV* paradigm. Different tabs or interactive sections of the DEW tool can be dedicated to each of the different divisions. In embodiments, the DEW tool can conform to the formalized rigor of the MV* patterns (MVC, MVVM, and/or MVP). In other embodiments, a level of leniency or deviation from the more formalized patterns can be implemented for the DEW tool. As used herein, the “DEW Model tab” and related objects are consistent with the “Model” division of the MV* pattern; the Presentation table and related objects are consistent with the “View” division of the MV* pattern; and the “Code Abstraction” tab and related objects are consistent with the “View Model” or “Controller” division of the MV* pattern.

Further, the divisions (of MV*) are bound to each other consistently using consistent bind objects, consistent GUI conventions (such as right-hand-side (RHS) to left-hand-side (LHS) columnar-matching techniques), and using common developer conventions. As a result, the DEW tool has a consistent and easy-to-learn “feel” from a developer perspective. Current research indicates that the DEW tool is able to reduce application coding and development time by approximately a half of the time it would otherwise take using more cumbersome tools. Further, the DEW tool utilizes abstraction principles, which permits an application developed in the DEW tool to be customized and ported to various platforms (e.g., ANDROID, IOS, WINDOWS, WEB, etc.) with minimal changes to the application constructs themselves. This reduces maintained times and costs tremendously over conventional approaches, which often have disjointed teams and code-bases for different platform implementations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

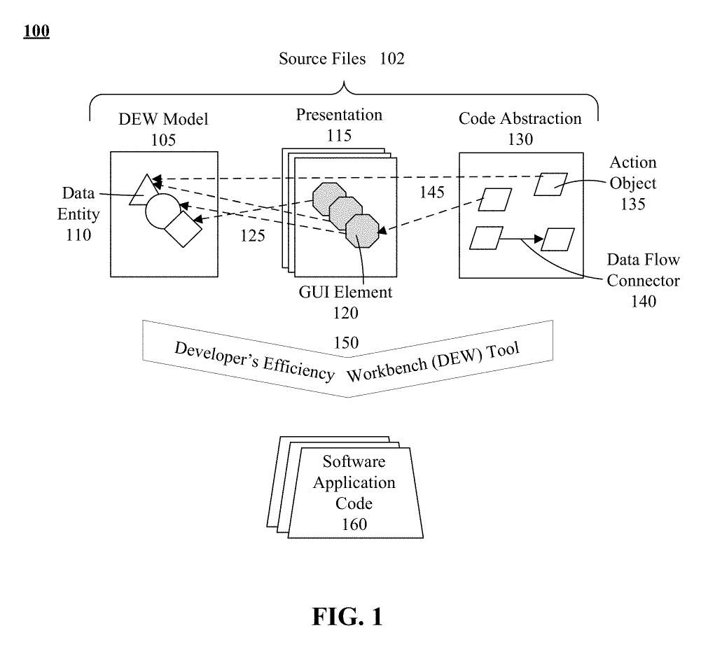

FIG. 1 is an illustration 100 expressing the basic premise of a software meta-development tool, the developer's efficiency workbench (DEW) tool 150 in accordance with embodiments of the inventive arrangements disclosed herein. The DEW tool 150 can be a software meta-development tool, a specialized software tool that supports a graphical and high-level approach to defining software functionality without requiring the developer to author the actual software code.

Like many software development tools, the DEW tool 150 can synthesize software application code 160 from user-created source files 102. Unlike conventional tools, the DEW tool 150 can be use the same set of source files 102 to generate multiple software application code 160 executables, each for a different platform and/or using a different programming language.

To achieve this level of flexibility and reusability, the source files 102 can follow a Model-View-Whatever (MV*) software architecture pattern (e.g., a Model-View-Controller (MVC) pattern, a Model-View-View Model (MVVM) pattern, etc.) in the logical separation of the expressions for the software application's data, user interface, and behavior, DEW model 105, presentation 115, and code abstraction 130, respectively.

The DEW model 105 can define the data entities 110 for use by the software application being developed. A variety of data sources, both internal and external, can be used for the data entities 110, such as a database query or Web service. Bi-directional data communication can be supported between the data entities 110 and their respective data sources. That is, changes made to the value of a data entity 110 can be propagated to its originating source.

The source files 102 can include one or more presentations 115. Each presentation 115 can represent a discrete graphical user interface (GUI) used by the software application to display information, including data entity 110 values, to a user. As such, each presentation 115 can be comprised of a variety of GUI elements 120. The relationship 125 between GUI elements 120 and the data entities 110 they display or handle can be expressed within the presentation 115. Conventional MV* patterns can exclude or forbid direct relationships 125 between data 110 and display elements 120.

The code abstraction 130 can represent the behaviors performed by the software application being developed as action objects 135 and data flow connectors 140. An action object 135 can be a high-level, platform and programming language independent, graphical placeholder that represents the software code for a behavior. Related action objects 135 can be connected to each other using data flow connectors 140. A data flow connector 140 can graphically express a directional relationship between the action objects 135 as well as represent any data type and/or format transformations that need to occur as data flows from the first action object 135 to the next.

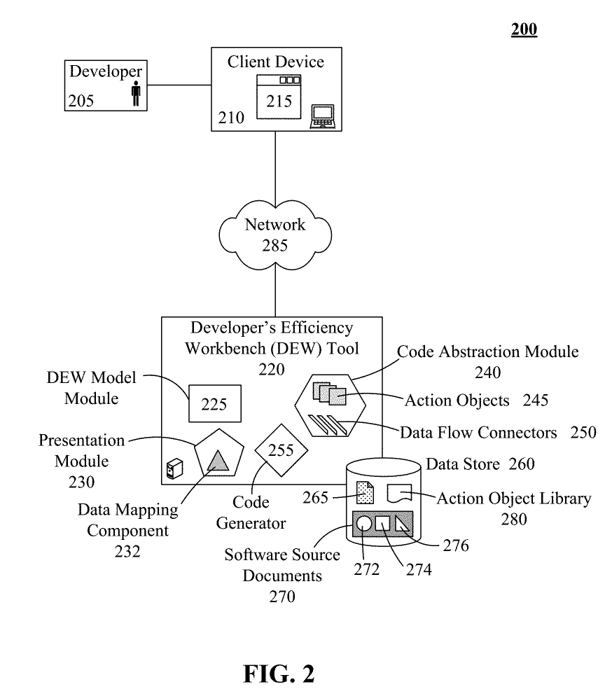

FIG. 2 is a block diagram illustrating a system 200 implementing a software meta-development tool, the developer's efficiency workbench (DEW) tool 220 in accordance with embodiments of the inventive arrangements disclosed herein. System 200 can implement the premise of illustration 100.

In system 200, a developer 205 can use a graphical user interface (GUI) 215 of the DEW tool 220 to develop a software application. The developer 205 can be a person having the requisite skills for software development using the DEW tool 220. The term “developer 205”, as used herein, can be interchangeable with the term “user”; a developer 205 can be a user having a specialized skill set.

The GUI 215 can represent the component of the DEW tool 220 that facilitates user interactions (e.g., data input, display data, etc.). The GUI 215 can run on a client device 210 used by the developer 205. The client device 210 can represent a variety of computing devices capable of supporting GUI 215 operations and communication with the DEW tool 220 over a network 285.

It should be noted that, although system 200 represents an implementation of the DEW tool 220 using a client-server architecture, other system architectures (e.g., service-oriented architecture (SOA), plug-in, monolithic, etc.) and/or configurations can be used without departing from the spirit of the present invention.

The DEW tool 220 can be a specific implementation of a software meta-development tool. In general, the DEW tool 220 (and software meta-development tool) can represent the hardware and software necessary to implement a software development environment capable of generating software code from source documents that include a graphical representation of a software application's functionality as high-level, platform and programming language independent elements. The DEW tool 220 can support software development practices, processes, and/or design patterns known in the Art.

Specifically, the DEW tool 220 can include a DEW model module 225, a presentation module 230, a code abstraction module 240, a code generator 255, a data store 260, and the like. The data store 260 can be used to store data 265, 270, and 280 that supports operation of the DEW tool 220. It should be noted that the components of the DEW tool 220 shown in system 200 can represent the core functionality and that additional components, such as a configuration management module, can be included to increase functionality.

The DEW model module 225, presentation module 230, and code abstraction module 240 can each be used by the developer 205 to create a corresponding source file—DEW model 272, presentation 274, and code abstraction 276—for a software application project 270. The software application project 270 can be a container for storing general data (e.g., name, intended platforms/languages, version, etc.) about and the source files 272, 274, and 276 that define the software application, as is common in the Art.

It should be noted that system 200 can present a simple representation (i.e., single source files) of a software application project 270 for the sake of discussion; more complex representations (i.e., dependencies, modular breakdown) can be utilized within the DEW tool 220.

The DEW model module 225 can represent the software component that supports generation of a DEW model 272. The DEW model 272 can be a collection (i.e., list) of data entities defined for use by the software application project 270. While a data entity represents data, the data of a data entity can come from a variety of sources, such as a database query, a Web service, or another DEW model 272 of the software application project 270, and can have various structures/types, such as a static value, a dynamic value, a dynamic event trigger, a data object, or a data collection. Therefore, the DEW model module 225 presents the developer 205 with the means to define the parameters for each data entity of the DEW model 272.

The presentation module 230 can generate one or more presentations 274 for the software application. A presentation 274 can define how and what data is displayed within a GUI of the software application. That is, the GUI can be designed using various elements or controls and the corresponding data entities in the DEW model 272 or action objects 245 of the code abstraction 276 can be linked to the GUI elements/controls. The presentation module 230 can utilize a data mapping component 232 to handle these relationships.

For example, a text box of the software application GUI for displaying an inventory quantity can be mapped to the corresponding data entity in the DEW model 272 that queries the inventory database for the value.

The presentation 274 can have a similar purpose as the view from a model-view-controller (MVC) or model-view-view model (MVVM) software architectural pattern, defining the graphical user interface of the software application. However, unlike an MVC or MVVM view, the presentation 274 can support data (DEW model 272) relationships; the MVC or MVVM view can be completely separated and unrelated to their corresponding data model. The software source documents 270 can include multiple presentations 274 for the software application.

The code abstraction module 240 can allow the developer 205 to create a code abstraction 276 for the software application. A code abstraction 276 can graphically represent the behavior or functionality of the software application using high-level, platform and programming language independent terms. As used herein, the term “high-level”, with respect to the code abstraction 276, can refer to terminology that represents a broader expression of a task and not a reference to a narrow expression of that task.

For example, the high-level term “find” can represent the task of finding something and that thing found can be influenced by particular parameters, whereas the term “find string” can only be used when finding a string; “find string” can implicitly embed the parameters within the term; the “find string” task can be performed by a “find” task that is provided with parameters that specify a string.

Conventional software development approaches can be focused on the narrow expressions of functionality, especially expressions that are related to a specific platform or programming language. The code abstraction 276 of the DEW tool 220 can eliminate the need for the developer 205 to know the specific name for a behavior, reducing the amount of time a developer 205 spends searching for this information.

The code abstraction 276 can be created using the action objects 245 and data flow connectors 250 provided by the code abstraction module 240. An action object 245 can be a graphical placeholder for the software code that implements the behavior of the software application like a “black box”. Each action object 245 can have an input stream and an output stream that are unconstrained by data type. That is, data type resolution for input/output variables can be performed during execution, not during development.

The action objects 245 that can be used within the code abstraction module 240 can be defined within an action object library 280 maintained by the DEW tool 220. The action object library 280 can be an inclusive list of action objects 245, however, a subset of the list can be presented to the developer 205 based upon the intended platforms and/or programming languages for the software application. That is, the developer 205 can be shown only those action objects 245 from the action object library 280 that are expressible in the intended programming languages (i.e., cannot use an action object 245 that is not supported by the programming language being used). Since action objects 245 are related to platform/programming language code, these relationships can be maintained in the action object library 280 for each action object 245.

Action objects 245 can be connected to each other using data flow connectors 250. A data flow connector 250 can graphically express a directional relationship between the action objects 245. Thus, a data flow connector 250 can be used to connect the output stream of one action object 245 to the input stream of another action object 245. It can be the responsibility of the developer 205 to ensure that validity of the sequential relationship between the connected action objects 245.

Additionally, the data flow connector 250 can define input data and/or transformation parameters. A transformation parameter can specify a data format or a data type. Thus, the data flow connector 250 can implicitly represent the data handling operations necessary to convert input data in accordance with the transformation parameters.

The lack of constraints on data types inherent in the code abstraction 276 can require the DEW tool 220 to utilize a means (i.e., software programming language or framework) that does not enforce strict data type binding like AngularJS.

The code generator 255 can represent the software algorithms that synthesize the DEW model 272, presentation 274, and code abstraction 276 into executable software code for a specified platform and/or programming language. In performing this task, the code generator 255 can additionally utilize a language library 265 and the action object library 280. The language library 265 can represent the syntax and/or specific code for the programming languages supported by the DEW tool 220. The programming languages can be packaged as modules that are added to the language library 265.

As used herein, presented data store 260 can be a physical or virtual storage space configured to store digital information. Data store 260 can be physically implemented within any type of hardware including, but not limited to, a magnetic disk, an optical disk, a semiconductor memory, a digitally encoded plastic memory, a holographic memory, or any other recording medium. Data store 260 can be a stand-alone storage unit as well as a storage unit formed from a plurality of physical devices. Additionally, information can be stored within data store 260 in a variety of manners. For example, information can be stored within a database structure or can be stored within one or more files of a file storage system, where each file may or may not be indexed for information searching purposes. Further, data store 260 can utilize one or more encryption mechanisms to protect stored information from unauthorized access.

Network 285 can include any hardware/software/and firmware necessary to convey data encoded within carrier waves. Data can be contained within analog or digital signals and conveyed though data or voice channels. Network 285 can include local components and data pathways necessary for communications to be exchanged among computing device components and between integrated device components and peripheral devices. Network 285 can also include network equipment, such as routers, data lines, hubs, and intermediary servers which together form a data network, such as the Internet. Network 285 can also include circuit-based communication components and mobile communication components, such as telephony switches, modems, cellular communication towers, and the like. Network 285 can include line based and/or wireless communication pathways.

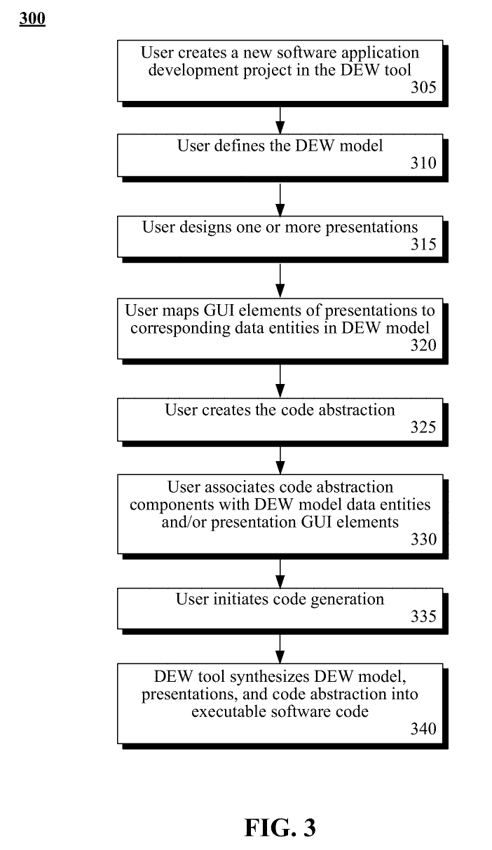

FIG. 3 is a flowchart of a method 300 describing the general use of the DEW tool in accordance with embodiments of the inventive arrangements disclosed herein. Method 300 can be performed within the context of system 200.

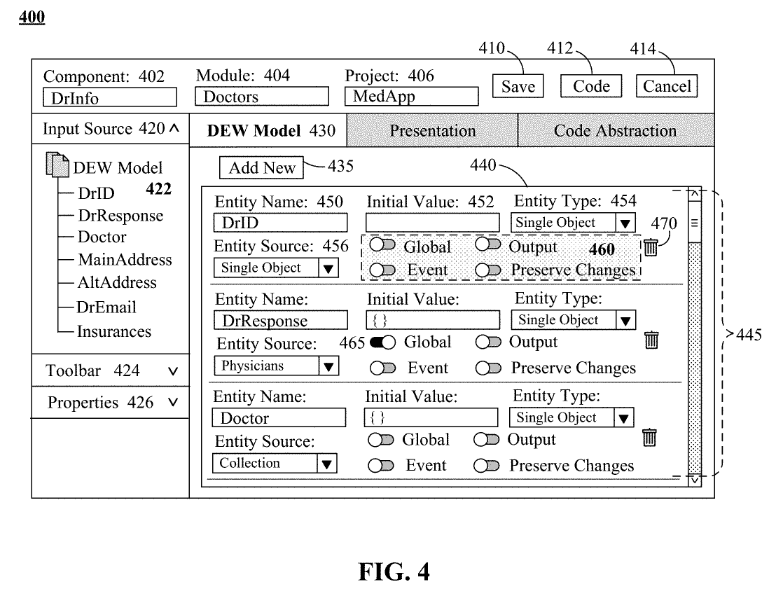

Method 300 can begin in step 305 where the user (developer) creates a new software application development project in the DEW tool. The user can define the DEW model in step 310; GUI 400 of FIG. 4 can be used for this step.

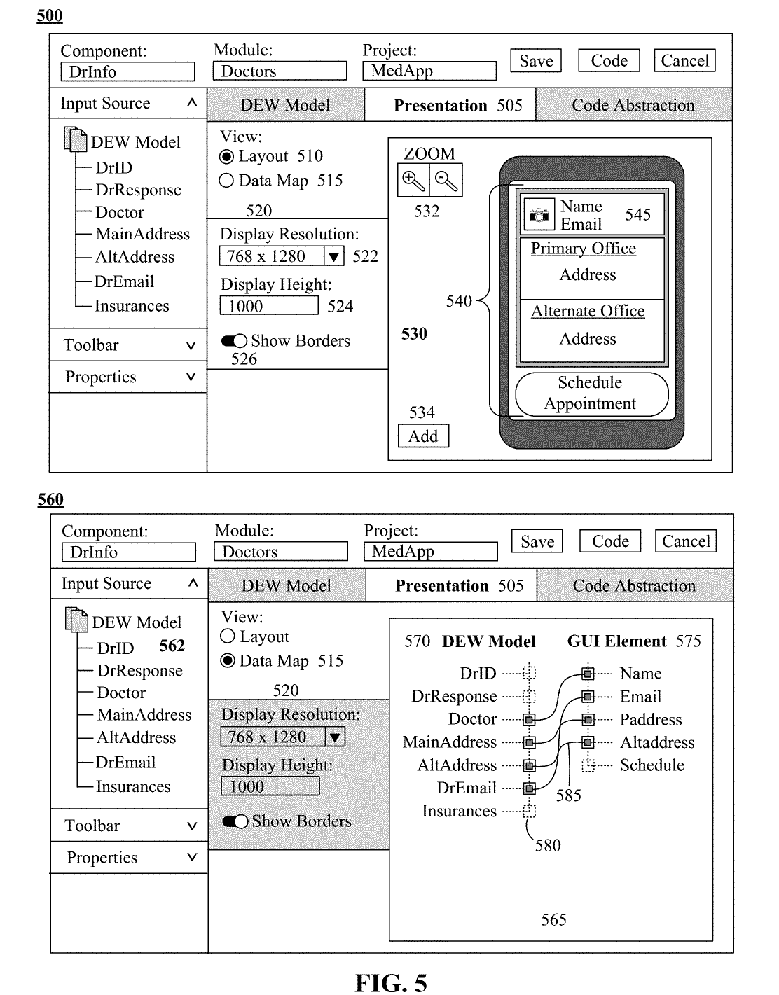

In step 315, the user can design one or more presentations, such as using GUI 500 from FIG. 5. The user can list map GUI elements of the presentations to the corresponding data entities in the DEW model in step 320; GUI 560 from FIG. 5 can illustrate this step.

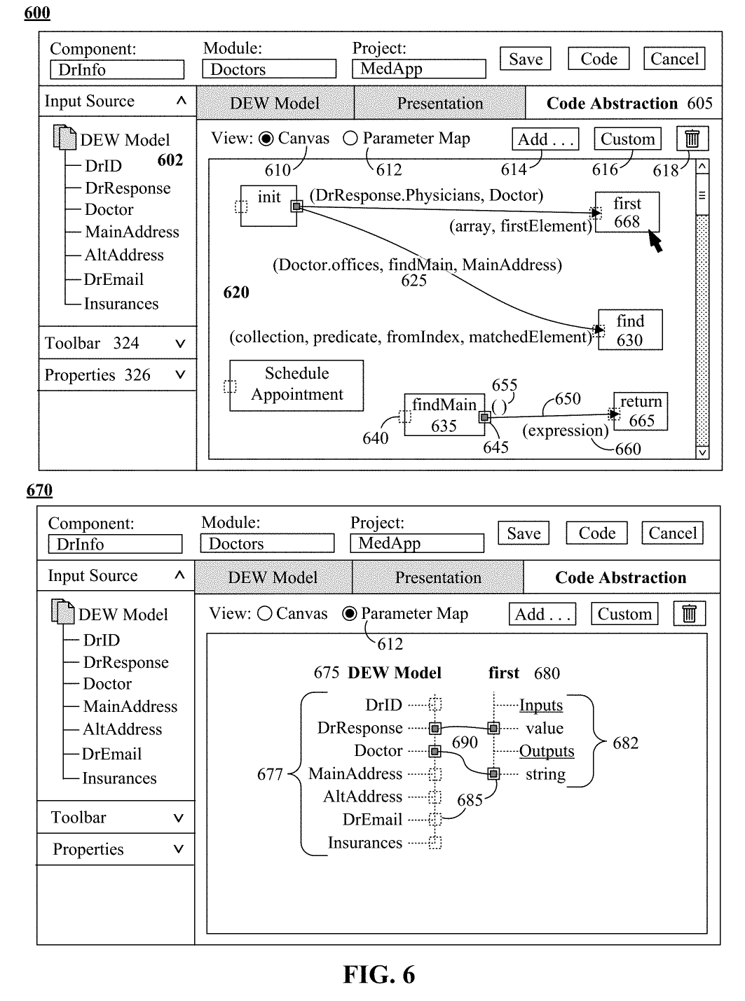

In step 325, the user can create the code abstraction for the software application. Step 325 can utilize the concepts taught in U.S. application Ser. No. 15/393,503, filed Dec. 29, 2016 entitled “APPLICATION DEVELOPMENT TOOL USING GRAPHIC OBJECTS TO BIND OBJECT SETS OF DIFFERENT DISTINCT DIVISIONS OF A DESIGN PATTERN”, as well as GUI 600 from FIG. 6. The user can associate code abstraction components (i.e., action objects and data flow connectors) with their related DEW model data entities and/or presentation GUI elements in step 330.

In step 335, the user can initiate code generation. Step 335 can require the user to specify the platforms and/or programming languages that the generated code should utilize. The DEW tool can synthesize the DEW model, presentations, and code abstraction into executable software code in step 340.

FIG. 4 is an illustration of an example DEW tool GUI 400 used to define the data entities 445 of the DEW model 422 in accordance with embodiments of the inventive arrangements disclosed herein. GUI 400 can represent a specific embodiment of the GUI 215 of system 200.

The GUIs depicted in FIGS. 4, 5, and 6 can share several general elements. Therefore, for the sake of brevity, these elements can be defined here, in FIG. 4, and omitted from the discussions of FIGS. 5 and 6.

The elements shared among the multiple GUIs 400, et al., can be used to provide over-arching information about the software application project and/or basic DEW tool controls. The top section of the GUI 400 can include fields that present identifiers for the component 402, module 404, and project 406 that the code abstraction is associated to inform the developer. The component 402 and module 404 can be logical separations of the software application. The project 406 can represent the container name for the software application source files (i.e., software application project 270). In these examples, the overall software application can be a medical application and the portion currently being worked on can be a doctor information component of a doctor module.

The top portion of the GUI 400 can also include general controls 410, 412, and 414. A save button 410 can trigger the current state of the source file being worked on to be stored. The code button 412 can invoke the code generator and may be disabled until specific conditions have been met. Changes made to the source file can be discarded via selection of the cancel button 414.

The left-hand side of the GUI 400 can present the developer with expandable/collapsible access to information about the input source 420 being used, the available toolbar 424, and properties 426. The input source 420 can display the list of the data entities defined for the DEW model 422 for reference purposes.

The DEW tool can provide access to the source files of the component 402 and/or module 404 being worked on as tabs. In GUI 400, the DEW model tab 430 can be selected to present the developer with data and controls that are specific to the DEW model 422.

The DEW model tab 430 can include an add button 435 and an area 440 configured to display/allow definition of data entities 445. The add button 435 can represent the mechanism by which a developer can add data entities 445 to the DEW model 422 and display area 440.

A variety of input controls 450-460 can be used to capture user-entered data for each data entity 445. In this example, the developer can enter the name 450 and initial value 452 of a data entity 445 into corresponding text fields. The type 454 and source 456 of the data entity 445 can be selected from drop-down menus. The values contained in the drop-down menus can represent those types 454 and sources 456 supported by the DEW tool. Additional windows can be triggered by some values of the drop-down menus like a query wizard to write a database query for the data entity 445.

Boolean controls 460 (e.g., checkboxes, switches, radio buttons, etc.) can allow the developer to “switch” specific properties of the data entity 445 off (circle to the left) and on 465 (the circle to the right). A delete button 470 can remove an associated data entity 445 from the DEW model 422.

FIG. 5 depicts example DEW tool GUIs 500 and 560 for creating a presentation in accordance with embodiments of the inventive arrangements disclosed herein. GUIs 500 and 560 can represent a specific embodiment of the GUI 215 of system 200.

In GUIs 500 and 560, the presentation tab 505 can be selected, presenting the developer with access to two views 510 and 515 for defining a presentation for the software application being developed. The layout view 510 can be shown in GUI 500; GUI 560 can show the data map view 515.

In the layout view 510, the developer can be provided with areas 520 and 530 to define the design parameters 522-526 for the graphic representation 540 of the user interface, respectively. The parameter area 520 can present controls that allow the developer to configure the display representation 540 in the design area 530. That is, the data selected in the parameter area 520 can change the display representation 540 presented in the design area 530.

In this example, the parameter area 520 can allow the developer to define a display resolution 522 and display height 524 of the presented display representation 540 as well as toggle whether borders 526 are shown in the design area 530. The selections available for the display resolution 522 and/or display height 524 can correspond to specific computing or mobile devices.

The design area 530 can include a zoom control 532 and an add button 534, in addition to the display representation 540. The display representation 540 can graphically represent the device display defined by the user-selections entered in the parameter area 520.

The zoom control 532, as is common in GUIs, can allow increased/decreased magnification of the display representation 540. The add button 534 can provide the means by which the developer inserts GUI elements 545 to the display representation 540. The add button 534 can “pop-up” a second window that presents the GUI elements 545, which can be dragged-and-dropped onto the display representation 540.

In another embodiment, the GUI elements 545 can be presented in a static display within the layout view 510 like the shapes in many graphic design tools.

In yet another contemplated embodiment, the developer can also be provided the means to customize the underlying code (e.g., HTML, XML, XAML, etc.) within the GUI elements 545 of the display representation 540. Such a means can be incorporated into the add button 534 and/or as a separate feature.

The GUI elements 545 can represent discrete components and/or sections of the display representation 540. The GUI elements 545 available to the developer within the layout view 510 can be restricted to those supported by the intended platform and/or programming language. In this example, the display representation 540 can include GUI elements 545 that present the name, email address, primary office address, and secondary office address of a doctor as well as the means to schedule an appointment with that doctor.

GUI 560 can present the data map view 515 of the display representation 540 presented in the layout view 510. In GUI 560, the design area 530 can be replaced with a data map 565. The left-side of the data map 565 can list the data entities 570 of the DEW model 562 and the right-side can list the GUI elements 575 of the display representation 540.

The data entities 570 in the data map 565 can be selectable as indicated by the boxes 580, unlike the DEW model 562 presented in the input source; the GUI elements 575 can also be selectable. Selection of a data entity 570 can allow the developer to draw a line 585 to a GUI element 575 and vice versa. This can allow the developer to graphically express relationships between GUI elements 575 and the data entities 570 of the DEW model 562.

FIG. 6 shows example DEW tool GUIs 600 and 670 for creating a code abstraction in accordance with embodiments of the inventive arrangements disclosed herein. GUI 600 can represent a specific embodiment of the GUI 215 of system 200.

In GUI 600, the code abstraction tab 605 can be selected to provide the developer with data and controls specific to the creation of a code abstraction. The code abstraction tab 605 can include the means to select the presented view 610 and 612, add 614 elements (e.g., action objects and data flow connectors) to the canvas 620, customize 616 action object code, and delete 618 elements.

GUI 600 can present the canvas view 610 of the code abstraction. In the canvas view 610, the action objects and data flow connectors comprising the code abstraction can be graphically displayed on a canvas 620. The canvas 620 can be the area of the GUI 600 that supports the manipulation of graphical elements in addition to textual elements.

The add button 614 can be used to add action objects and data flow connectors to the canvas 620. The add button 614 can present a pop-up window listing action objects (from the action object library) and/or data flow connectors that can dragged-and-dropped onto the canvas 620, similar to other graphic software tools. Likewise, the custom button 616 can pop-up a window having a code editor where the developer can enter software code.

As shown in this example, action objects can be represented by generically-named boxes and data flow connectors can be lines having an arrowhead. The action objects findMain 635 and return 665 can be used for discussion purposes.

The findMain 635 action object can be the box that represents code that finds the address of the main office of a doctor; a specific customized implementation of the find 630 action object. The findMain 635 action object can have an input 640 and output 645 stream represented by smaller boxes and adhering to a left-to-right flow (i.e., enter from the left and exit to the right). The input 640 of findMain 635 can be blank because the findMain 635 action object is called from data flow connector 625, which passes findMain 635 the data entity ‘Doctor.offices’; Doctor can be a data entity of the DEW model 602.

The output 645 for findMain 635 can be connected to a return 665 action object with a data flow connector 650. Data flow connector 650 can indicate that the output 645 of findMain 635 is to be the input of the return 665 action object. Thus, data flows from findMain 635 to return 665, as indicated by the arrowhead.

Further, the data flow connector 650 can express that it accepts the output 645 of findMain 635, regardless of type or format, as indicated by parentheses 655 and provides return 665 with an expression 660 as input. The expression 660 can be a transformation parameter of the data flow connector 650, meaning that the output 645 from findMain 635 should be converted to an expression 660 before being input into the return 665 action object.

GUI 670 can present a parameter map view 612 of the first 668 action object selected in the canvas view 610. In GUI 670, the canvas 620 can be replaced with a parameter map of the action object called ‘first’ 680. The left side of the parameter map can list the data entities 677 of the DEW model 675 and the right side can list the elements 682 of the input and output streams of the ‘first’ 680 action object.

The data entities 677 of the DEW model 675 can be selectable as indicated by the boxes 685, unlike the DEW model 602 presented in the input source; the input/output stream elements 682 of the ‘first’ 680 action object can also be selectable. Selection of a data entity 677 can allow the developer to draw a line 690 to a stream element 682 and vice versa. This can allow the developer to graphically express relationships between action object input/output stream elements 682 and the data entities 677 of the DEW model 675.

Thus, the example parameter map shown in GUI 670 can read as the ‘first’ 680 action object receives a value 682 from the DrResponse data entity 677 as input and provides the Doctor data entity 677 with a string 682.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A developer's efficiency workbench (DEW) tool comprising:
a DEW model module configured to create a DEW model for a software application, wherein the DEW model is a list of user-defined data entities available for use by the software application;
a presentation module configured to create at least one presentation for the software application, wherein a presentation defines a graphical user interface (GUI) for the software application, wherein GUI elements defined in the presentation are able to be linked with respective data entities in the DEW model;
a code abstraction module configured to create a code abstraction for the software application, wherein the code abstraction is a high-level, graphical, platform and programming language independent representation of behaviors performed by the software application, wherein elements of the code abstraction are able to be linked to corresponding data entities of the DEW model or GUI elements of the at least one presentation;
a language library storing at least one of syntax and software code for at least one programming language; and
a code generator configured to synthesize the DEW model, at least one presentation, and code abstraction into a set of executable software code implementing the software application using the language library, wherein manual authoring of the software code by a user is unnecessary.

2. The DEW tool of claim 1, wherein the code abstraction further comprises:
a plurality of action objects each having an input stream and an output stream, wherein an action object is a graphical placeholder for a behavior, wherein the action object has an input stream and an output stream that are unconstrained by data type; and
at least one data flow connector, wherein each data flow connector connects the output stream of a first action object to the input stream of a second action object, wherein the first and second action objects are sequentially-related, wherein the data flow connector graphically expresses a directional relationship between the connected action objects and defines input data and transformation parameters, wherein a transformation parameter specifies one of a data format and a data type, wherein the data flow connector implicitly represents data handling operations necessary to convert the input data in accordance with the transformation parameters.

3. The DEW tool of claim 2, wherein data represented by the code abstraction is presented as a canvas view and a parameter map view, wherein the canvas view allows graphical manipulation of the plurality of action objects and the at least one data flow connector within a designated area of a graphical user interface (GUI), and the parameter map view allows linkages to be made between the data entities of the DEW model on a left-hand side and a list of input and output variables for the respective input and output streams of a user-selected action object on a right-hand side, wherein data respective to linkages made in the parameter map view are propagated to corresponding representations in the canvas view.

4. The DEW tool of claim 2, further comprising:
an action object library defining the plurality of action objects able to be used in the code abstraction, wherein an entry for each action object in the action object library includes at least one reference to a platform or programming language-specific implementation of the behavior.

5. The DEW tool of claim 1, wherein a user-defined data entity of the DEW model comprises one of a variable, a query string, an event trigger, and a data object.

6. The DEW tool of claim 1, wherein data represented by the at least one presentation is presented as a layout view and a data map view, wherein the layout view allows graphical manipulation of GUI elements, and the data map view allows linkages to be made between the data entities of the DEW model on a left-hand side and a list of the GUI elements on a right-hand side.

7. The DEW tool of claim 1, wherein the DEW model, at least one presentation, and the code abstraction substantially conform to a Model-View-Whatever software architecture pattern.

8. The DEW tool of claim 1, wherein code generator is capable of generating a plurality of sets of executable software code using the DEW model, at least one presentation, and the code abstraction, wherein each set of executable software code utilizes a different programming language.

9. A software development method comprising:
creating a DEW model for a software application in a developer's efficiency workbench (DEW) tool, wherein the DEW model is a list of user-defined data entities available for use by the software application;
creating at least one presentation for the software application, wherein a presentation defines a graphical user interface (GUI) for the software application, wherein GUI elements defined in the presentation are able to be linked with respective data entities in the DEW model;
creating a code abstraction for the software application, wherein the code abstraction is a high-level, graphical, platform and programming language independent representation of behaviors performed by the software application, wherein elements of the code abstraction are able to be linked to corresponding data entities of the DEW model or GUI elements of the at least one presentation; and
generating a set of executable software code implementing the software application as defined in the DEW model, at least one presentation, and the code abstraction, wherein the software code is generated for at least one of execution on a user-specified platform and using a user-specified programming language, wherein manual authoring of the software code by a user is unnecessary.

10. The method of claim 9, wherein creating the code abstraction further comprises:
expressing each behavior of the software application as an action object on a canvas, wherein the action object is a graphical placeholder for a behavior, wherein the action object has an input stream and an output stream that are unconstrained by data type; and
when required, connecting the output stream of a first action object to the input stream of a second action object with a data flow connector on the canvas, wherein the first and second action objects are sequentially-related, wherein the data flow connector graphically expresses a directional relationship between the first and second action objects and defines input data and transformation parameters, wherein a transformation parameter specifies one of a data format and a data type, wherein the data flow connector implicitly represents data handling operations necessary to convert the input data in accordance with the transformation parameters.

11. The method of claim 10, wherein expressing each behavior further comprises:
selecting the action object from an action object library maintained by the software meta-development tool; and
placing the selected action object on the canvas via a drag-and-drop mechanism.

12. The method of claim 10, wherein, when deemed necessary by a user, expressing behavior further comprises:
selecting the action object on the canvas;
invoking a means for inputting software code;
inputting software code into said means; and
storing the inputted software code, wherein the stored software code is associated with the selected action object, wherein said stored software code is used to replace or augment default software code associated with the action object during generation of the executable software code.

13. The method of claim 10, further comprising:
accessing a parameter map of a user-selected action object, wherein said parameter map presents a list of DEW model data entities on a left-hand side and a list of input and output variables for the respective input and output streams of the user-selected action object on a right-hand side; and
linking a data entity to one of an input variable and an output variable of the user-selected action object, wherein said linkage is graphically expressed as a line between both lists, wherein data respective to linkages made in the parameter map are propagated to corresponding representations on the canvas.

14. The method of claim 9, wherein creating the at least one presentation further comprises:
accessing a data map for the presentation, wherein said data map presents a list of DEW model data entities on a left-hand side and a list of GUI elements on a right-hand side; and
linking a data entity to a GUI element, wherein said linkage is graphically expressed as a line between both lists.

15. A computer program product comprising a computer readable storage medium having computer usable program code embodied therewith, the computer usable program code comprising:
computer usable program code configured to allow creation of a DEW model for a software application, wherein the DEW model is a list of user-defined data entities available for use by the software application;
computer usable program code configured to allow creation of at least one presentation for the software application, wherein a presentation defines a graphical user interface (GUI) for the software application, wherein GUI elements defined in the presentation are able to be linked with respective data entities in the DEW model;
computer usable program code configured to allow creation of a code abstraction for the software application, wherein the code abstraction is a high-level, graphical, platform and programming language independent representation of behaviors performed by the software application, wherein elements of the code abstraction are able to be linked to corresponding data entities of the DEW model or GUI elements of the at least one presentation; and
computer usable program code configured to generate a set of executable software code implementing the software application as defined by the DEW model, at least one presentation, and the code abstraction, wherein the software code is generated for at least one of execution on a user-specified platform and using a user-specified programming language, wherein manual authoring of the software code by a user is unnecessary.

16. The computer program product of claim 15, wherein creating the code abstraction further comprises:
computer usable program code configured to allow expressing each behavior of the software application as an action object on a canvas, wherein the action object is a graphical placeholder for a behavior, wherein the action object has an input stream and an output stream that are unconstrained by data type; and
computer usable program code configured to, when required, allow connection of the output stream of a first action object to the input stream of a second action object with a data flow connector on the canvas, wherein the first and second action objects are sequentially-related, wherein the data flow connector graphically expresses a directional relationship between the first and second action objects and defines input data and transformation parameters, wherein a transformation parameter specifies one of a data format and a data type, wherein the data flow connector implicitly represents data handling operations necessary to convert the input data in accordance with the transformation parameters.

17. The computer program product of claim 16, wherein expressing each behavior further comprises:
computer usable program code configured to allow selection of the action object from an action object library; and
computer usable program code configured to allow placement of the selected action object on the canvas via a drag-and-drop mechanism.

18. The computer program product of claim 16, wherein, when deemed necessary by a user, expressing behavior further comprises:
computer usable program code configured to allow selection of the action object on the canvas;
computer usable program code configured to allow invocation a means for inputting software code;
computer usable program code configured to allow inputting software code into said means; and
computer usable program code configured to allow storing of the inputted software code, wherein the stored software code is associated with the selected action object, wherein said stored software code is used to replace or augment default software code associated with the action object during generation of the executable software code.

19. The computer program product of claim 16, further comprising:
computer usable program code configured to allow access to a parameter map of a user-selected action object, wherein said parameter map presents a list of DEW model data entities on a left-hand side and a list of input and output variables for the respective input and output streams of the user-selected action object on a right-hand side; and
computer usable program code configured to allow linking of a data entity to one of an input variable and an output variable of the user-selected action object, wherein said linkage is graphically expressed as a line between both lists, wherein data respective to linkages made in the parameter map are propagated to corresponding representations on the canvas.

20. The computer program product of claim 15, wherein creating the at least one presentation further comprises:
computer usable program code configured to allow access to a data map for the presentation, wherein said data map presents a list of DEW model data entities on a left-hand side and a list of GUI elements on a right-hand side; and
computer usable program code configured to allow linking a data entity to a GUI element, wherein said linkage is graphically expressed as a line between both lists.
